(19) United States
(12) Patent Application Publication
(10) Pub. No.: US 2020/0305488 A1
(43) Pub. Date: Oct. 1, 2020

(54) HUMAN MILK FORTIFIER

(71) Applicant: SOCIETE DES PRODUITS NESTLE S.A, Vevey (CH)

(72) Inventors: Aristea BINIA, Fribourg (CH); Norbert SPRENGER, Savigny (CH); Tinu Mary SAMUEL, Epalinges (CH)

(73) Assignee: Societe des Produitis Nestle S.A., Vevey (CH)

(21) Appl. No.: 16/628,735

(22) PCT Filed: Jul. 5, 2018
(86) PCT No.: PCT/EP2018/068267

§ 371 Date: Jan. 6, 2020

(30) Foreign Application Priority Data
Jul. 7, 2017 (EP) 17180278.8

(51) Int. Cl. A23L 33/125; A23L 33/00; A23L 33/155; A23L 33/16; A23L 33/17

(52) U.S. Cl. CPC A23L 33/125; A23L 33/40; A23V 2002/00; A23L 33/16; A23L 33/17; A23L 33/155

(57) ABSTRACT

A human milk fortifier composition comprising one or more human milk oligosaccharides. Said human milk fortifier composition may be tailored to fortify the breast milk of a woman who has given birth by Caesarean section.

### TECHNICAL FIELD OF THE INVENTION

The present invention relates to a human milk fortifier composition, more specifically to a human milk fortifier composition comprising human milk oligosaccharides. In particular the present invention relates to a human milk fortifier composition specifically tailored for an infant or child born by C-section for consumption as a supplement to human breast milk. The invention furthermore relates to the use of said milk fortifier composition.

### BACKGROUND OF THE INVENTION

Caesarean section rates are increasing around the world; whilst the international health care community considers that an ideal caesarean section rate to be between 10 to 15%, it is believed that today's rate may be higher than 30% in some countries.

The reasons for caesarean sections vary. In many cases a caesarean section is necessary to save the life of the baby or the mother, this may be because a vaginal birth is not possible, e.g. because of failure of the normal progression of labor. In other cases a caesarean section may be elective and performed at the request of a patient.

Regardless of the reason for a caesarean section, infants born in this way are considered to be at an increased risk of suffering from a variety of health complaints in infancy, childhood, and later life. The reasons for this increased risk is not clear. However, given the increasing frequency of cesarean sections, there is a need to identify factors that may contribute to this risk and to address them.

The inventors have identified a factor that may contribute to this risk. In particular the inventors have found that the concentration of one or more human milk oligosaccharides (herein after “HMOs”) found in human breast milk (hereinafter “HM”) produced by mothers to infants born via caesarean section (hereinafter C-section), may differ from the concentration found in HM produced by mothers to infants born via vaginal delivery. More particularly the inventors have found that the concentration of an HMO found in HM produced by mothers to infants born via vaginal delivery may be higher than the concentration of the same HMO found in HM produced by mothers to infants born via C-section delivery.

HMOs are, collectively, the third largest solid constituents in human milk, and a variety of benefits have been associated with them, in consequence, an optimal intake of these compounds in infancy and childhood is believed to be necessary to ensure optimum health and development. HMOs have for example been linked to a variety of biological functions including the establishment of gut microbiota, the composition of which has been identified as differing between infants delivered via C-section and infants delivered vaginally, e.g. in the first 6 months life.

Accordingly, there is need for milk fortifiers comprising one or more HMO that can be used to fortify HM produced by mothers who have given birth via C-section, and to optimise the intake of one or more HMO in infants and children delivered via C-section.

### SUMMARY OF THE INVENTION

The invention is set out in the claims and in the detailed description included herein. The inventors have found that the concentration of an HMO found in HM produced by mothers to infants born via vaginal delivery may be higher than the concentration of the same HMO found in HM produced by mothers to infants born via C-section. In light of this finding, the inventors have developed a human milk fortifier composition comprising one or more HMOs.

Said human milk fortifier may be tailored to fortify the breast milk of a women who has given birth via caesarean section. The purpose being to ensure that infants born by caesarean section do not receive less of one or more HMO than an infant born via vaginal delivery.

The one or more HMO may be a sialylated oligosaccharide, a fucosylated oligosaccharide, an N-acetylated oligosaccharide, or any combination thereof. The one or more HMO may for example be selected from the group consisting of; 2′-fucosyllactose, 3′-fucosyllactose, 3′-sialyllactose, 6′-galactosyllactose, difucosyllacto-N-Hexose-a, fucosyllacto-N-hexose-III, Lacto-N-fucosylpentaose-I, Lacto-N-fucosylpentaose-III, Lacto-N-fucosylpentaose-V, Lacto-N-hexaose (A), Lacto-N-Neodifucosylhexaose, Lacto-N-Neofucosylpentaose, Lacto-N-Neotetraose, Lacto-N-Tetraose, and any combination thereof.

It may be particularly beneficial if the HMO is selected from the group consisting of; 2′-fucosyllactose, 3′-sialyllactose, 6′-galactosyllactose, Lacto-N-fucosylpentaose-III, Lacto-N-Neodifucosylhexaose, Lacto-N-Neotetraose, and any combination thereof.

The human milk fortifier composition may comprise an HMO in a range of 0.1 to 10000 mg/L.

The human milk fortifier may be specifically tailored to supplement breastmilk produced for up an infant of an age selected from the group consisting of; up to 4 months of age, up to 3 months of age, up to 2 months of age, up to 1 months of age, up to 2 weeks of age, and up to 1 week of age. It may for example be specifically tailored to supplement breastmilk produced for up an infant of up to one month of age or up to 2 weeks of age. The infant may have been born via caesarean section.

The human milk fortifier may further comprise one or more ingredient selected from the group consisting of vitamins, minerals, protein, carbohydrates, and probiotics.

Further provided is a method of preparing a human milk fortifier composition tailored to fortify the breast milk of a women who has given birth via caesarean section, said method comprising the steps of: measuring out an appropriate amount of a human milk fortifier composition and mixing it with a diluent and/or additive, then method may also comprise the step of determining whether the woman has given birth via caesarean section.

Also provided is a human milk fortifier as defined herein, for use in fortifying human breast milk and in particular human breastmilk from a woman who has given birth via C-section.

The human milk fortifier as defined herein may to provide an optimised amount of one or more HMO to an infant. The infant may be selected from the group consisting of: preterm infants and term infants. The infant may be an infant born via caesarean section.

Also provided is a nutritional system comprising:
a. a human milk fortifier composition tailored to fortify the breast milk of women who have given birth via caesarean section, and
b. A human milk fortifier composition e.g. a human milk fortifier tailored to fortify the breastmilk of women who have given birth via vaginal delivery,
   wherein, said human milk fortifier composition tailored to fortify the breast milk of women who have given birth via caesarean section comprises one or more HMO in a concentration higher than in the human milk fortifier composition.

### DRAWINGS

FIG. 1 is a graphical representation of the 2′-fucosyllactose concentration found in HM by delivery mode at 2 days (V1), 17 days (V2), 30 days (V3) 60 days(V4), 90 days (V5), and 120 days (V6) postpartum.

FIG. 2 is a graphical representation of the 3′-sialyllactose concentration found in HM by delivery mode at 2 days (V1), 17 days (V2), 30 days (V3) 60 days(V4), 90 days (V5), and 120 days (V6) postpartum.

FIG. 3 is a graphical representation of the 6′-galactosyllactose concentration found in HM by delivery mode at 2 days (V1), 17 days (V2), 30 days (V3) 60 days(V4), 90 days (V5), and 120 days (V6) postpartum.

FIG. 4 is a graphical representation of the Lacto-N-fucosylpentaose-III concentration found in HM by delivery mode at 2 days (V1), 17 days (V2), 30 days (V3) 60 days(V4), 90 days (V5), and 120 days (V6) postpartum.

FIG. 5 is a graphical representation of the Lacto-N-Neodifucosylhexaose concentration found in HM by delivery mode at 2 days (V1), 17 days (V2), 30 days (V3) 60 days(V4), 90 days (V5), and 120 days (V6) postpartum.

FIG. 6 is a graphical representation of the Lacto-N-Neotetraose concentration found in HM by delivery mode at 2 days (V1), 17 days (V2), 30 days (V3) 60 days(V4), 90 days (V5), and 120 days (V6) postpartum.

FIG. 7 is a graphical representation of the 3′-fucosyllactose concentration found in HM by delivery mode at 2 days (V1), 17 days (V2), 30 days (V3) 60 days(V4), 90 days (V5), and 120 days (V6) postpartum.

FIG. 8 is a graphical representation of the difucosyllacto-N-Hexose-a concentration found in HM by delivery mode at 2 days (V1), 17 days (V2), 30 days (V3) 60 days(V4), 90 days (V5), and 120 days (V6) postpartum.

FIG. 9 is a graphical representation of the fucosyllacto-N-hexose-III concentration found in HM by delivery mode at 2 days (V1), 17 days (V2), 30 days (V3) 60 days(V4), 90 days (V5), and 120 days (V6) postpartum.

FIG. 10 is a graphical representation of the Lacto-N-fucosylpentaosed concentration found in HM by delivery mode at 2 days (V1), 17 days (V2), 30 days (V3) 60 days(V4), 90 days (V5), and 120 days (V6) postpartum.

FIG. 11 is a graphical representation of the Lacto-N-fucosylpentaose-V concentration found in HM by delivery mode at 2 days (V1), 17 days (V2), 30 days (V3) 60 days(V4), 90 days (V5), and 120 days (V6) postpartum.

FIG. 12 is a graphical representation of the Lacto-N-hexaose (A) concentration found in HM by delivery mode at 2 days (V1), 17 days (V2), 30 days (V3) 60 days(V4), 90 days (V5), and 120 days (V6) postpartum.

FIG. 13 is a graphical representation of the Lacto-N-Neofucosylpentaose concentration found in HM by delivery mode at 2 days (V1), 17 days (V2), 30 days (V3) 60 days(V4), 90 days (V5), and 120 days (V6) postpartum.

FIG. 14 is a graphical representation of the Lacto-N-Neotetraose concentration found in HM by delivery mode at 2 days (V1), 17 days (V2), 30 days (V3) 60 days(V4), 90 days (V5), and 120 days (V6) postpartum.

FIG. 15 is a graphical representation of the Lacto-N-Tetraose concentration found in HM by delivery mode at 2 days (V1), 17 days (V2), 30 days (V3) 60 days(V4), 90 days (V5), and 120 days (V6) postpartum.

### DETAILED DESCRIPTION

In a first aspect of the present invention there is provided a human milk fortifier composition comprising one or more HMO.

The term “human milk fortifier composition” as used herein, refers to a nutritional composition for use in combination and in admixture with human breast milk. Unless otherwise specified, the term “human milk fortifier composition” specifically excludes conventional infant formulas that provide the sole or primary source of infant nutrition and that are not typically combined and admixed with human milk to supplement human milk feedings.

The term “fortifier” refers to a composition which comprises one or more nutrients having a nutritional benefit for infants, both preterm infants and term infants. The fortifier according to the present invention is rich in HMOs and may therefore be considered as an HMO fortifier, HMO supplement or the like.

In an embodiment of the invention, the human milk fortifier composition is specifically tailored/adapted to fortify the breast milk of women who have given birth via caesarean section. A human milk fortifier, as disclosed herein, may be considered as specifically tailored/adapted to fortify the breast milk of a woman who has given birth via c-section if it comprises one or more HMO as described herein. Said human milk fortifier may, for example, comprise said one or more HMO in an amount sufficient to address the deficiency of one or more HMO identified in the human breast milk of mothers who have given birth by C-section in comparison to mothers who have given birth vaginally. A sufficient amount of an HMO may for example be an amount equal to or greater than an amount that an infant born by vaginal delivery would receive, or may for example, be any amount that is equal to or higher than the difference found in the concentration e.g. averages, in human milk produced by women who have given birth via vaginal delivery and women who have given birth by c-section delivery. Said human milk fortifier composition may be a delivery mode specific human milk fortifier i.e. a milk fortifier sold specifically for use in women who have given birth via C-section e.g. marketed as a being for use to fortify the breastmilk of women who have given birth by C-section.

The term “C-section” as used herein refers to a caesarean section in general. The cesarean section may have been a planned/elective C-section, or an emergency C-section.

The term “infant” as used herein, refers to humans of less than about 1 year of age. The term includes preterm infants, premature infants, small for gestational age (SGA) infants and/or infant with low birth weight (LBW).

The terms “preterm infants” or “premature infants” as used herein, refer to infants who were not born at term. Generally they refers to infants born alive prior to 37 weeks of gestation/pregnancy.

The term “small for gestational age infant” as used herein, refers to an infant who is smaller in size than normal for their gestational age at birth, most commonly defined as a weight below the 10th percentile for the gestational age. In some embodiments, SGA may be associated with intrauterine growth restriction (IUGR), which refers to a condition in which a foetus is unable to achieve its potential size.

The term “low birth weight infants” as used herein refers to an infant that has a body weight under 2500 g at birth. It therefore encompasses:
infants who have/had a body weight from 1800 to 2500 g at birth (usually called “low birth weight” or LBW)
infants who have/had a body weight from 1000 to 1800 g at birth (called “very low birth weight” or VLBW)
infants who have/had a body weight under 1000 g at birth (called “extremely low birth weight” or ELBW)

Infants or young children with low birth weight may or may not be preterm, and similarly, infants or young children who were small for gestational age may or may not be preterm.

The term “child” as used herein, refers to humans from about 1 to about 7 year of age, for example, between 1 and 3 years of age.

The human milk fortifier composition of the invention may comprise any type of HMO.

In an embodiment of the present invention the delivery mode specific human milk fortifier comprise a HMO selected from the group consisting of a sialylated oligosaccharide, a fucosylated oligosaccharide, a N-acetylated oligosaccharide, or any combination of the foregoing.

The term “sialylated oligosaccharide” as used herein refers to an oligosaccharide having a sialic acid (such as N-acetylneuraminic acid and/or N-glycolylneuraminic acid) residue.

The term “N-acetylated” oligosaccharide as used herein refers to an oligosaccharide having at least one hexose carrying an N-acetyl residue.

The term “fucosylated oligosaccharide” as used herein refers to an oligosaccharide having a fucose residue.

In a more specific embodiment the human milk fortifier composition of the invention comprises an HMO selected from the group consisting of: 2′-fucosyllactose, 3′-fucosyllactose, 3′-sialyllactose, 6′-galactosyllactose, difucosyllacto-N-Hexose-a, fucosyllacto-N-hexose-III, Lacto-N-fucosylpentaose-I, Lacto-N-fucosylpentaose-III, Lacto-N-fucosylpentaose-V, Lacto-N-hexaose, Lacto-N-Neodifucosylhexaose, Lacto-N-Neofucosylpentaose, Lacto-N-Neotetraose, Lacto-N-Tetraose, and any combination thereof.

In an even more specific embodiment the human milk fortifier composition of the invention comprises an HMO selected from the group consisting of: 2′-fucosyllactose, 3′-sialyllactose, 6′-galactosyllactose, Lacto-N-fucosylpentaose-III, Lacto-N-Neodifucosylhexaose, Lacto-N-Neotetraose, and any combination thereof.

The human milk fortifier composition of the invention may comprise an HMO in any concentration.

In particular the human milk fortifier composition may comprise one an HMO in a concentration of 0.1 to 10000 mg/L e.g. 0.1 to 8000 mg/L.

The concentrations listed herein may refer to a concentration after a composition has been reconstituted or mixed with water or milk.

The human milk fortifier composition of the invention may for example comprise one or more of the HMOs listed in table I in a concentration range listed in table I.

TABLE I

| HMO | Concentration Range mg/L |
|---|---|
| 2′ - Fucosyllactose | 8-10,000 |
| 3 - Fucosyllactose | 10-6000 |
| 3′ - Sialyllactose | 10-500 |
| 6′ - Galactosyllactose | 10-500 |
| Difucosyllacto-N-Hexaose-a | 10-850 |
| Fucosyllacto-N-Hexaose-III | 10-1500 |
| Lacto-N-Fucosylpentaose-I | 10-4500 |
| Lacto-N-Fucosylpentaose-III | 10-1200 |
| Lacto-N-Fucosylpentaose-V | 10-500 |
| Lacto-N-hexaose (A) | 10-900 |
| Lacto-N-Neodifucosylhexaose | 10-300 |
| Lacto-N-Neofucosylpentaose | 10-100 |
| Lacto-N-Neotetraose | 10-700 |
| Lacto-N-Tetraose | 10-5500 |

In an embodiment of the present invention the human milk fortifier composition of the invention may comprise one or more of the HMOs listed in table II in the concentration range listed in table II.

TABLE II

| HMO | Concentration Range mg/L |
|---|---|
| 2′ - Fucosyllactose | 33-800 |
| 3 - Fucosyllactose | 5-800 |
| 3′ - Sialyllactose | 0.1-20 |
| 6′ - Galactosyllactose | 0.2-20 |
| Difucosyllacto-N-Hexaose-a | 0.2-45 |
| Fucosyllacto-N-Hexaose-III | 4-35 |
| Lacto-N-Fucosylpentaose-I | 30-290 |
| Lacto-N-Fucosylpentaose-III | 8-90 |
| Lacto-N-Fucosylpentaose-V | 1-15 |
| Lacto-N-hexaose (A) | 0.1-8 |
| Lacto-N-Neodifucosylhexaose | 1.2-30 |
| Lacto-N-Neofucosylpentaose | 1.2-4 |
| Lacto-N-Neotetraose | 0.1-43 |
| Lacto-N-Tetraose | 21-130 |

The human milk fortifier of the invention may be tailored to fortify breastmilk for an infant or child of any age.

In an embodiment of the present invention the human milk fortifier composition is tailored/adapted for up an infant of an age selected from the group consisting of; up to 4 months of age, up to 3 months of age, up to 2 months of age, up to 1 month of age, up to 2 weeks of age, up to 1 week of age. For example the human milk fortifier composition may be tailored/adapted to fortify breastmilk produced for an infant up to 1 month of age e.g. up to 2 weeks of age.

In an embodiment of the present invention the human milk fortifier is tailored/adapted for an infant of up to 1 month of age e.g. an infant up to 2 weeks of age, or an infant up to 1 week of age and said composition comprises one or more HMO selected from the group consisting of 2′-fucosyllactose, 3′-sialyllactose, 6′-galactosyllactose, Lacto-N-fucosylpentaose-III, Lacto-N-Neodifucosylhexaose, Lacto-N-Neotetraose, and any combination thereof. In a more specific embodiment said HMOs, if present in said human milk fortifier tailored/adapted for an infant of up to 1 month of age, may be present in a concentration range as set out in table III. In an even more specific embodiment, said human milk fortifier is tailored/adapted for an infant of up to 2 weeks of age.

TABLE III

| HMO | Concentration Range mg/L |
|---|---|
| 2′ - Fucosyllactose | 400-10000 e.g. 400-800 |
| 3 - Fucosyllactose | 1-2500 e.g. 39-800 |
| 6′ - Galactosyllactose | 12 to 300 e.g. 12 to 18 |
| Lacto-N-Fucosylpentaose-III | 27-1200 e.g. 43-78 |
| Lacto-N-Neodifucosylhexaose | 22-320 e.g.22-30 |
| Lacto-N-Neotetraose | 22-650 e.g. 22-43 |

The human milk fortifier composition of the invention can also comprise any other ingredients or excipients known to be employed in human milk fortifier compositions.

Non limiting examples of such ingredients include: proteins, amino acids, carbohydrates, lipids, prebiotics or probiotics, essential fatty acids, nucleotides, nucleosides, vitamins, minerals and other micronutrients.

In an embodiment of the invention the human milk fortifier composition further comprises one or more ingredients selected from the group consisting of vitamins, minerals, protein, carbohydrates, and probiotics.

Non limiting examples of proteins include: casein, alpha-lactalbumin, whey, soy protein, rice protein, corn protein, oat protein, barley protein, wheat protein, rye protein, pea protein, egg protein, sunflower seed protein, potato protein, fish protein, meat protein, lactoferrin, serum albumin, immunoglobins, and combinations thereof.

Non limiting examples of amino acids include leucine, threonine, tyrosine, Isoleucine, arginine, alanine, histidine, isoleucine, proline, valine, cysteine, glutamine, glutamic acid, glycine, serine, arginine, lysine, methionine, phenylalanine, tryptophane, asparagine, aspartic acid, and combinations thereof.

Non limiting examples of digestible carbohydrates include lactose, saccharose, maltodexirin, starch, and combinations thereof.

Non limiting examples of lipids include: palm olein, high oleic sunflower oil, high oleic safflower oil, canola oil, fish oil, coconut oil, bovine milk fat, and combinations thereof.

Non limiting examples of essential fatty acids include: linoleic acid (LA), a-linolenic acid (ALA) and polyunsaturated fatty acids (PUFAs). The gender specific synthetic nutritional compositions of the invention may further contain gangliosides monosialoganglioside-3 (GM3) and disialogangliosides 3 (GD3), phospholipids such as sphingomyelin, phospholipids phosphatidylcholine, phosphatidylethanolamine, phosphatidylinositol, phosphatidylserine, and combinations thereof.

None limiting examples of non-digestible carbohydrates (prebiotics) include: oligosaccharides (other than HMOs) optionally containing fructose, galactose, mannose; dietary fibers, in particular soluble fibers, soy fibers; inulin; and combinations thereof. Preferred prebiotics are fructo-oligosaccharides (FOS), galacto-oligosaccharides (GOS), isomalto-oligosaccharides (IMO), xylo-oligosaccharides (XOS), arabino-xylo oligosaccharides (AXOS), mannan-oligosaccharides (MOS), oligosaccharides of soy, glycosylsucrose (GS), lactosucrose (LS), lactulose (LA), palatinose-oligosaccharides (PAO), malto-oligosaccharides, gums and/or hydrolysates thereof, pectins and/or hydrolysates thereof, and combinations of the foregoing.

Non limiting examples of probiotics include: Bifidobacterium, Lactobacillus, Lactococcus, Enterococcus, Streptococcus, Kluyveromyces, Saccharoymces, Candida, in particular selected from the group consisting of Bifidobacterium longum ssp longum, Bifidobacterium lactis, Bifidobacterium animalis, Bifidobacterium breve, Bifidobacterium longum ssp infantis, Bifidobacterium adolescentis, Lactobacillus acidophilus, Lactobacillus casei, Lactobacillus paracasei, Lactobacillus salivarius, Lactobacillus lactis, Lactobacillus rhamnosus, Lactobacillus johnsonii, Lactobacillus plantarum, Lactobacillus salivarius, Lactococcus lactis, Enterococcus faecium, Saccharomyces cerevisiae, Saccharomyces boulardii or mixtures thereof, preferably selected from the group consisting of Bifidobacterium longum NCC3001 (ATCC BAA-999), Bifidobacterium longum NCC2705 (CNCM 1-2618), Bifidobacterium longum NCC490 (CNCM 1-2170), Bifidobacterium lactis NCC2818 (CNCM 1-3446), Bifidobacterium breve strain A, Lactobacillus paracasei NCC2461 (CNCM 1-2116), Lactobacillus johnsonii NCC533 (CNCM 1-1225), Lactobacillus rhamnosus GG (ATCC53103), Lactobacillus rhamnosus NCC4007 (CGMCC 1.3724), Enterococcus faecium SF 68 (NCC2768; NCIMB10415), and combinations thereof.

Non limiting examples of Nucleotides include: cytidine monophosphate (CMP), uridine monophosphate (UMP), adenosine monophosphate (AMP), guanosine monophosphate (GMP), and combinations thereof.

Non limiting examples of vitamins and minerals include: vitamin A, vitamin B1, vitamin B2, vitamin B6, vitamin Bi2, vitamin E. vitamin K. vitamin C, vitamin D, folic acid, inositol, niacin, biotin, pantothenic acid, choline, calcium, phosphorous, iodine, iron, magnesium, copper, zinc, manganese, chloride, potassium, sodium, selenium, chromium, molybdenum, taurine, L-carnitine, and combinations thereof. Minerals are usually added in salt form.

Other suitable and desirable ingredients of human milk fortifier compositions, that may be employed in the human milk fortifier compositions of the invention, are described in guidelines issued by the Codex Alimentarius.

The human milk fortifier composition of the invention may be prepared in any way known in the art to prepare human milk fortifier compositions. It is well within the purview of the skilled person to decide on a method depending on the type of human milk fortifier in question e.g. powder or liquid. An exemplary method for preparing a human milk fortifier in accordance with the invention is set out below.

A human milk fortifier may be prepared, for example, by blending together lipid, protein, HMO, and other carbohydrates in appropriate proportions. If used, emulsifiers may be included in the blend at this stage. The vitamins and minerals may be added at this stage but are usually added later to avoid thermal degradation. Any lipophilic vitamins, such as vitamin A, D, E and K, and emulsifiers may be dissolved into the fat source prior to blending. Water, preferably water which has been subjected to reverse osmosis, may then be mixed in to a liquid mixture.

The liquid mixture may then be thermally treated to reduce bacterial loads. For example the liquid mixture may be rapidly heated to a temperature on the range of about 80° C. to about 110° C. for about 5 seconds to about 5 minutes. This may be carried out by steam injection or by heat exchanger, for example a plate heat exchanger.

The liquid mixture may then be cooled to about 60° C. to about 85° C., for example by flash cooling. The liquid mixture may then be homogenised, for example in two stages at about 7 MPa to about 40 MPa in the first stage and about 2 MPa to about 14 MPa in the second stage. The homogenised mixture may then be further cooled and any heat sensitive components, such as vitamins and minerals may be added. The pH of the homogenised mixture is conveniently standardised at this point.

The homogenized liquid mixture is then filled into suitable containers, preferably aseptically. However, the liquid composition may also be reported in the container. Suitable apparatus for carrying out filling of this nature is commercially available.

A human milk fortifier composition specifically tailored/adapted to fortify the breast milk of a women who has given birth via caesarean section may be prepared from a human milk fortifier composition e.g. a human milk fortifier composition not specifically tailored to fortify the breast milk of a woman who has given birth via a particularly delivery mode e.g. C-section or vaginal delivery.

Accordingly, in another aspect of the present invention there is provided a method of preparing a human milk fortifier composition tailored to fortify the breast milk of a women who has given birth via C-section, said method comprising the steps of: measuring out an appropriate amount of a human milk fortifier composition e.g. a human milk fortifier composition not specifically tailored to fortify the breast milk of a woman who has given birth via a particularly delivery mode, and mixing it with an additive and/or a diluent e.g. one or more HMOs and/or water, so as to arrive at a human milk fortifier composition tailored to fortify the breast milk of a women who has given birth via C-section in accordance with the invention.

The additive may be a one or more HMO e.g. one or more HMO in a concentration such, that that when the additive is mixed with a human milk fortifier composition, and optionally a diluent, the resulting mixture is a human milk fortifier tailored to fortify the breast milk of a women who has given birth via C-section, in accordance with the invention.

The additive may be a delivery mode specific additive e.g. an additive marketed as specifically being for use by women who have given birth by C-section.

In another aspect of the present invention there is provided a human milk fortifier in accordance with the invention, for use in fortifying human breast milk.

In an embodiment the human breastmilk is breastmilk from women who have given birth via caesarean section.

In another aspect of the present invention there is provided a human milk fortifier composition in accordance with the invention, for use to provide an optimised amount and/or to prevent the sub-optimal intake of one or more HMO to an infant or child born via C-section. An optimised amount of one or more HMO would be an amount equal to or greater than an amount e.g. the average amount, that an infant born by vaginal delivery would be considered to receive e.g. an amount of an HMO set out in table I, II or III included herein.

In another aspect of the present invention there is provided a human milk fortifier composition in accordance with the invention, for use in optimising the health and development and/or preventing the sub-optimal health and development e.g. growth and dvelopment of an infant or child born via C-section.

The human milk fortifier compositions of the invention may not only optimise the health and development of an infant or child born via C-section short term, but may also do so in the long term.

In another aspect of the present invention there is provided a human milk fortifier composition in accordance with the invention, for use in optimising the gut microbiota and/or preventing sub-optimal gut microbiota in an infant or child born via C-section. HMOs are known to be important for the establishment of gut microbiota and therefore an optimal supply of HMOs may lead to an optimised gut microbiota.

In another aspect of the present invention there is provided the use of a human milk fortifier composition in accordance with the invention, in the manufacture of a composition for use in optimising the gut microbiota in an infant or child born via C-section.

A non-optimal gut microbiota may be one showing presence of one or several pathobionts and/or opportunistic pathobionts and/or their toxins and/or virulence factors and/or antibiotic resistence genes. An optimal gut microbiota may be one not showing presence of one or several pathobionts and/or opportunistic pathobionts and/or their toxins and/or virulence factors and/or antibiotic resistence genes.

The human milk fortifier compositions of the invention may not only optimise the gut microbiota composition short term, but may also do so in the long term.

Long term effects may only be evident in months or years e.g. 6 months, 9 months, 12 months, 5 years, 10 years, or 20 years

In another aspect of the present invention there is provided the use of a human milk fortifier composition in accordance with the invention, to fortify human breast milk and to improve/prevent sub-optimal breastmilk quality wherein said breastmilk is from a women who have given birth by C-section.

The quality of breastmilk in a woman who has given birth by C-section may be considered sub-optimal if it comprises one or more HMO in a concentration less than that found in breastmilk from a woman who has given birth vaginally e.g. in a concentration less than the average found in woman who have given birth vaginally.

In another aspect of the present invention there is provided the use of a human milk fortifier according to the invention to optimise and/or prevent the sub-optimal health and development and/or gut flora composition in an infant or child born via C-section.

Health and development and/or gut flora composition may be optimised short term or long term.

A human milk fortifier tailored to fortify the breastmilk of a woman who has given birth via C-section may be included in a nutritional system.

The term “nutritional system” as used herein refers to a collection of more than one synthetic nutritional compositions advertised or sold as part of the same product range e.g. a collection of human milk fortifiers and/or infant formulas sold under the same brand and adapted/tailored to the nutritional needs of infants born vis different delivery modes e.g. C-section or vaginally. The synthetic nutritional compositions making up the nutritional system may be packaged individually e.g. in capsules or boxes. Said packages can be sold individually, grouped together e.g. wrapped by plastic film or combined in a box, or in a combination of these two ways. The nutritional system may also comprise synthetic nutritional compositions for children older than 12 months.

In a further aspect of the present invention there is provided a nutritional system comprising:
a. a human milk fortifier composition tailored to fortify the breast milk of women who have given birth via caesarean section, in accordance with the invention, and
b. a human milk fortifier composition e.g. a human milk fortifier composition not specifically tailored to fortify the breast milk of a woman who has given birth via a particularly delivery mode,
   wherein,
said human milk fortifier composition tailored to fortify the breast milk of women who have given birth via caesarean section comprises one or more HMOs in a concentration higher than in the human milk fortifier composition e.g. human milk fortifier composition not specifically tailored to fortify the breast milk of a woman who has given birth via a particularly delivery.

The concentration of one or HMO in the human milk fortifier tailored for a woman who has given birth by C-section may be higher by any amount.

In an embodiment the human milk fortifier composition tailored for a woman who has given birth by C-section comprises one or more of the HMO listed in table II in a higher amount. The higher amount may be an amount within the range given in table II for the HMO in question.

In a more specific embodiment the human milk fortifier composition tailored for a woman who has given birth by C-section comprises one or more of the HMOs listed in table III in a higher amount. The higher amount may be an amount within the range given in table III for the HMO in question.

It should be appreciated that all features of the present invention disclosed herein can be freely combined and that variations and modifications may be made without departing from the scope of the invention as defined in the claims. Furthermore, where known equivalents exist to specific features, such equivalents are incorporated as if specifically referred to in this specification. There now follows a series of non-limiting examples that serve to illustrate the invention.

### EXAMPLES

### Example 1

Longitudinal Clinical Trial:

The present inventors designed a longitudinal clinical trial with lactating mothers with milk sampling at 2 days (V1), 17 days (V2), 30 days (V3) 60 days(V4), 90 days (V5), and 120 days (V6) postpartum. The milk samples were quantitatively analysed using a validated liquid chromatography method for HMOs.

The data presented here is from a multi-center, exploratory study with the primary objective of characterizing key nutrient components in human breast milk. Healthy women of any ethnicity having decided to exclusively breast-feed their new born infant from birth to 4 months of infant's age were recruited during the last 3 months of pregnancy, and their infants were followed up until 4 months of age.

Breast milk samples were collected from the mother at the following days postpartum: 0-3 (V1), 17±3 (V2), 30±3 (V3), 60±5 days (V4), 90±5 days (V5) and 120±5 days (v6). Samples were collected after full expression from one breast using a milk pump (Symphony Breastpump, Medela), while the baby was fed on the other breast to produce a satisfactory let-down. All efforts were made to collect complete feed that included fore-, mid-, and hind-milk as a representation of one feed and to avoid within feed variation of lipid and other nutrient contents. Approximately 30 mL aliquot was separated into two conical 15 mL polypropylene tubes for analysis and the rest was returned to the mother to feed the infant. Samples collected for research were stored at −80° C. and shipped on dry ice for analyses to the Nestlé Research Center, Lausanne, Switzerland.

Information on delivery mode (vaginal versus C-section) was collected along with other maternal sociodemographic and anthropometric characteristics. The concentrations of HMOs were measured in breast milk at all the time points as described below.

HMO were analysed by ulta high performance liquid chromatography (UHPLC) with fluorescence detection (FLD) after labelling with anthranilamide (2AB). Milk samples (50 μL), or HMO standard solutions (50 μL) were mixed with laminaritriose solution (0.5 μmol/mL; 50 μL), used as internal standard. 2AB labelling solution (2AB, 0.35 mol/L+sodium cyanoborohydride, 1.0 mol/L in DMSO containing 30% acetic acid; 200 μL) was added and the solution heated at 65° C. for 2 h. After 2 h the samples (and standards) were cooled to 4° C. for 10 min and diluted with a solution of acetonitrile/water (75/25; 600 μL). After mixing well, the solutions were placed in a centrifuge (10000×g; 5 min) to remove particulates and the supernatant transferred to vials suitable for the UHPLC autosampler.

The HMO were separated on a Waters BEH Glycan column (2.1×150 mm, 1.7 μm), preceded by a Waters BEH Amide Pre-column (2.1×5.0 mm, 1.7 μm) plumbed in to the system in such a way to act as a trapping column for removal of the excess labelling reagents (previously described by Benet & Austin, 2011) using the gradient described below. The 2AB-labelled oligosaccharides were detected by monitoring their fluorescence using λex=330 nm and λem=420 nm. Quantification was performed against standards of the genuine HMO for 2′FL, 3FL, A-tetrasaccharide, 3′SL, 6′SL, LNT, LNnT, LNFP-I, LNFP-V, and LNnFP. All other HMO were quantified against maltotriose assuming an equimolar response of the 2AB-labelled oligosaccharides. The following conditions were used for Separation of HMO on a BEH Glycan Column:

| | | Mobile | | 10 ports | |
|---|---|---|---|---|---|
| Time | Flow | phase* | | valve | |
| (min) | (mL/min) | % A | % B | position | Comment |
| 0.0 | 0.5 | 95.0 | 5.0 | 10 - 1 | Inject 5.0 μL |
| | | | | | Sample loading on trapping |
| | | | | | col. |
| 2.3 | 0.5 | 95.0 | 5.0 | 10 - 1 | Switch valve - start |
| 2.5 | 0.5 | 90.0 | 10.0 | 1 - 2 | acquisition |
| 4.9 | 0.5 | 90.0 | 10.0 | 1 - 2 | Elution |
| 32.1 | 0.5 | 82.0 | 18.0 | 1 - 2 | |
| 48.1 | 0.5 | 80.5 | 19.5 | 1 - 2 | |
| 61.5 | 0.5 | 78.0 | 22.0 | 1 - 2 | |
| 89.0 | 0.5 | 74.6 | 25.4 | 1 - 2 | |
| 89.5 | 0.4 | 30.0 | 70.0 | 1 - 2 | Washing analytical col. |
| 92.0 | 0.4 | 30.0 | 70.0 | 1 - 2 | |
| 93.0 | 0.4 | 90.0 | 10.0 | 1 - 2 | Re-equilibrate analytical col. |
| 98.0 | 0.5 | 90.0 | 10.0 | 10 - 1 | Autozero/switch valve/ |
| | | | | | stop acquisition |
| 99.0 | 0.5 | 95.0 | 5.0 | 10 - 1 | Equilibrate trapping col. |
| 99.5 | 0.5 | 95.0 | 5.0 | 10 - 1 | End |

Benet, T. & Austin, S. (2011) On-line clean-up for 2-aminobenzamide-labeled oligosaccharides, Anal.Chem. 414: 166-168. http://dx.doi.org/10.1016/j.ab.2011.03.002

The results of the compositional analysis were then subject to a statistical analysis.

A linear mixed model was used to model each HMO in which visit, mode of delivery, country and interaction between visit and mode of delivery were used as fixed effects. The within subject variability due to longitudinal repeat measures were taken care of in the model by declaring subject as a random effect.

The following statistical model was employed:

HMO˜Timepoint*Delivery mode+Country+e

Timepoint*Delivery mode and Country refers to the fixed effects of the model and takes into consideration the interactions between timepoint and delivery mode.

e refers to the random effect of the model which controls for within subject variability.

The results of the Statistical analysis (statistical inference) are show in in tables X-Y.

The timeframe differences along with the corresponding P-values are shown.

Note that Logarithmic transformation was required on some of the HMOs as their distributions were skewed.

Estimated differences were calculated from the model using the “contrast” function from the library with the same name.

All analyses were done using the statistical software R version 3.2.3

Logarithmic transformation was done for the following HMOs:
Fucosyllacto-N-Hexaose-III
Difucosyllacto-N-Hexaose-a
Lacto-N-hexaose (A)
Lacto-N-hexaose (B)
Lacto-N-Neodifucosylhexaose
Lacto-N-Tetraose
Lactodifucosyllactose
Sialyllacto-N-Tetraose b
Sialyllacto-N-Tetraose c

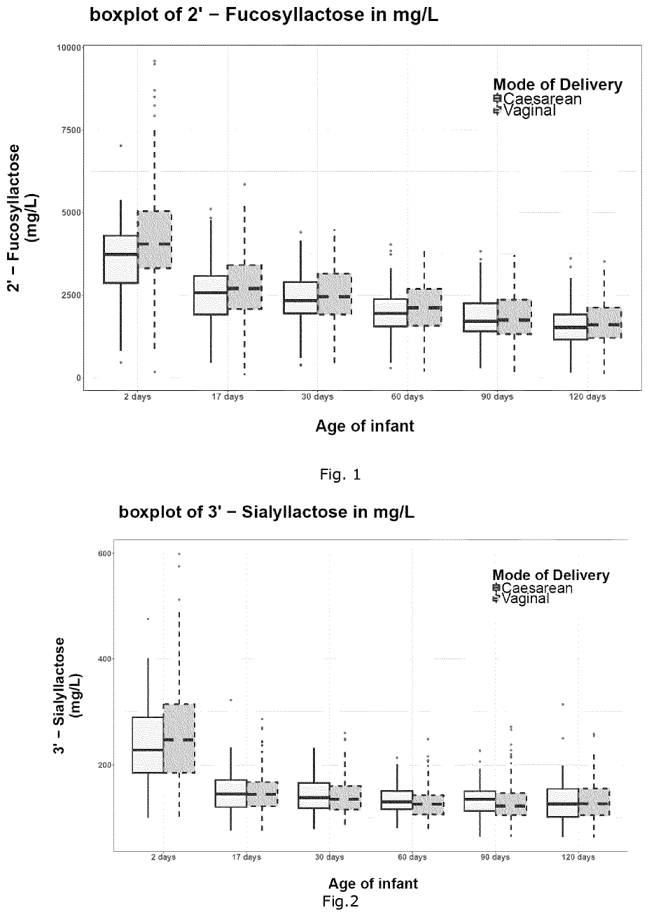

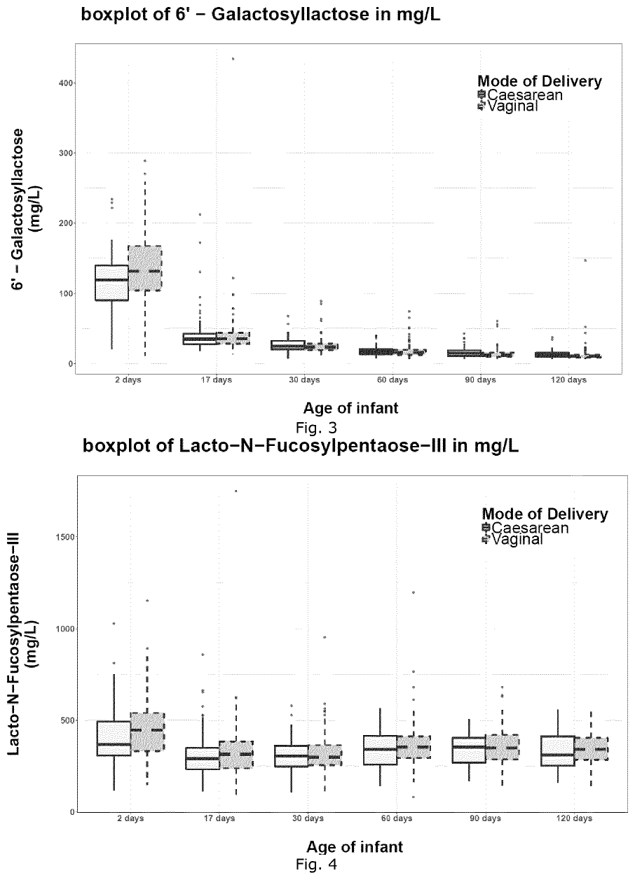

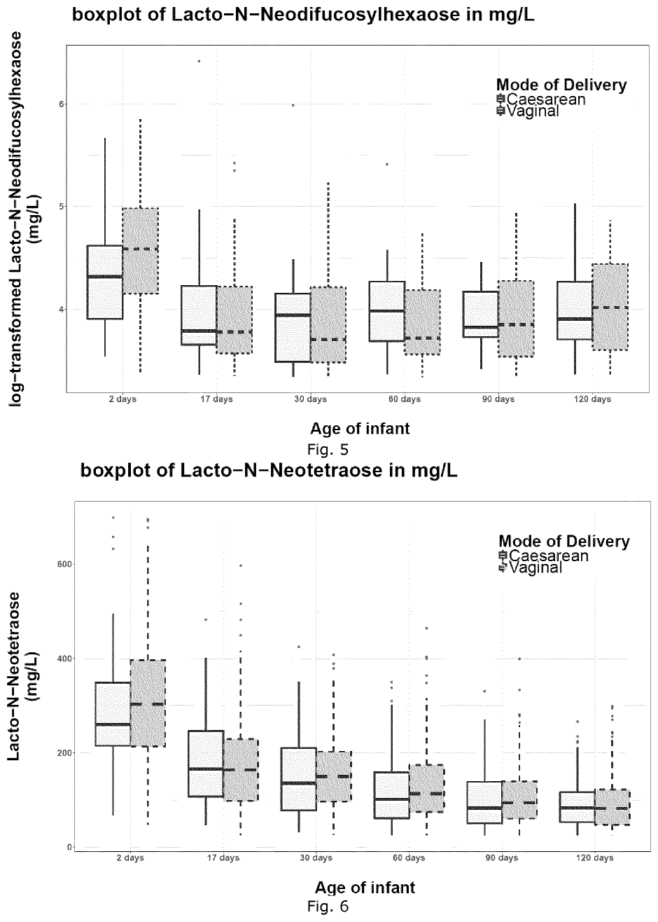

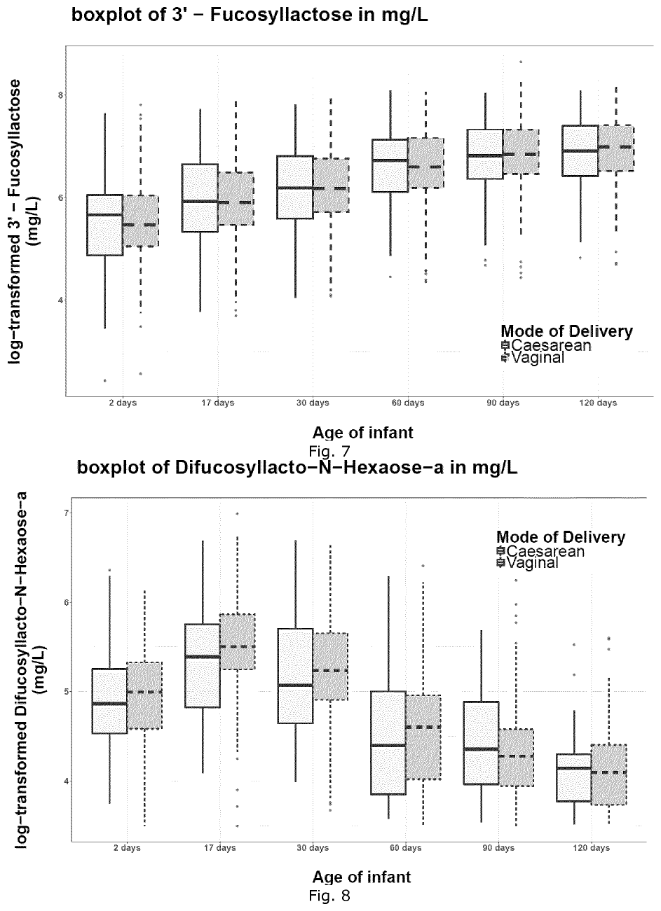

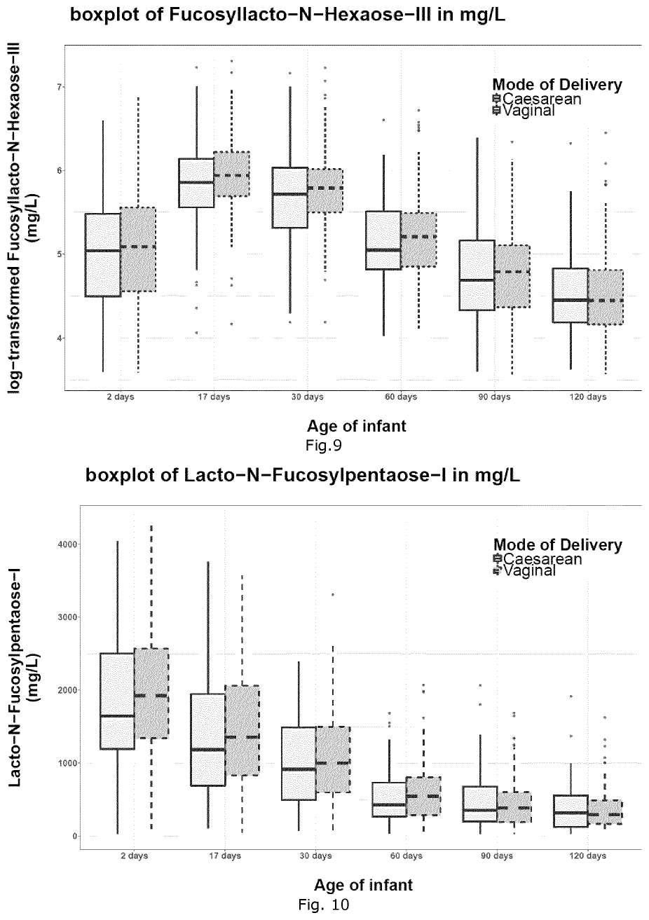

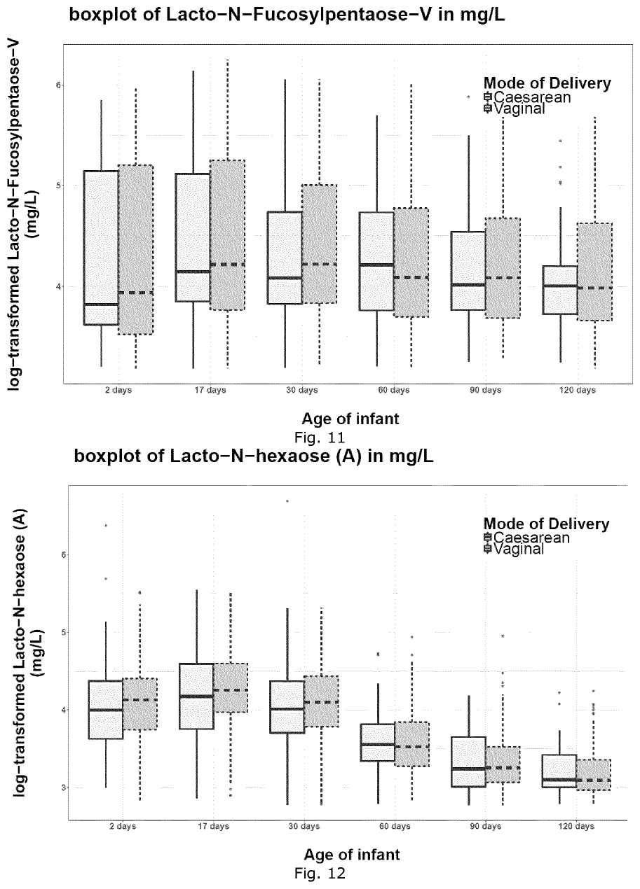

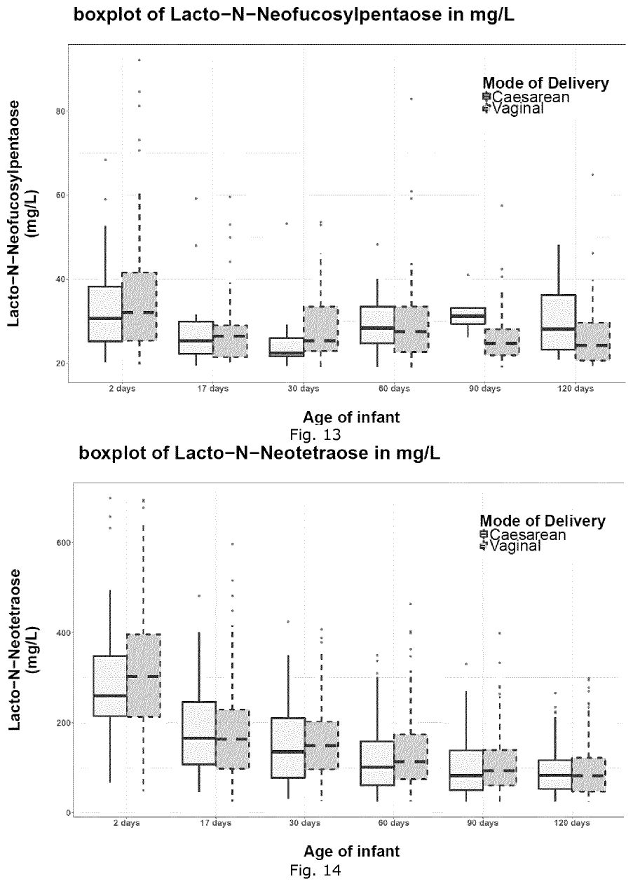

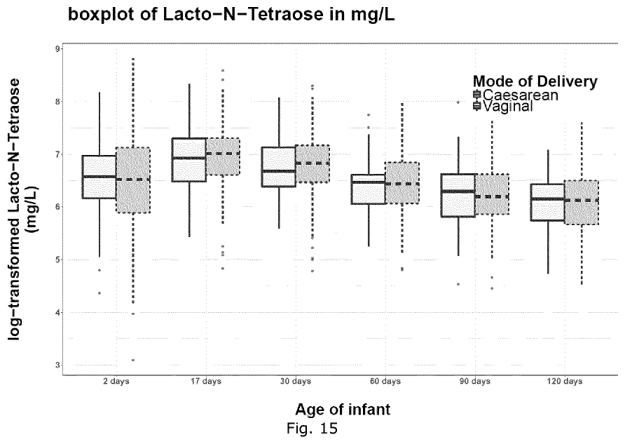

The results of the Statistical analysis (statistical inference) are show in in tables IV-XXIII and FIGS. 1 to 15. P value tables are given in the table beneath the compound and results to which they refer.

TABLE IV

| param | unit | DELITYP | visit | N | mean | sd | median | q1.25% | q3.75% | min | max |
|---|---|---|---|---|---|---|---|---|---|---|---|
| 2′-Fucosyllactose | mg/L | Caesarean | V1 | 59 | 3138.296 | 1638.898 | 3447.026 | 2383.618 | 4156.984 | 13.65675 | 7023.978 |
| 2′-Fucosyllactose | mg/L | Caesarean | V2 | 60 | 2561.761 | 1061.557 | 2551.873 | 1866.852 | 3067.853 | 46.72345 | 5101.178 |
| 2′-Fucosyllactose | mg/L | Caesarean | V3 | 53 | 2369.96 | 942.5247 | 2321.036 | 1933.275 | 2865.25 | 40.545 | 4398.074 |
| 2′-Fucosyllactose | mg/L | Caesarean | V4 | 47 | 1923.337 | 902.1145 | 1915.118 | 1464.509 | 2377.47 | 19.265 | 4026.608 |
| 2′-Fucosyllactose | mg/L | Caesarean | V5 | 46 | 1793.11 | 819.3643 | 1700.811 | 1398.518 | 2215.12 | 18.6093 | 3820.308 |
| 2′-Fucosyllactose | mg/L | Caesarean | V6 | 45 | 1579.751 | 731.179 | 1521.237 | 1154.809 | 1916.153 | 159.2499 | 3608.299 |
| 2′-Fucosyllactose | mg/L | Vaginal | V1 | 148 | 3911.249 | 2011.88 | 3911.41 | 2882.36 | 4983.837 | 13.17979 | 9589.387 |
| 2′-Fucosyllactose | mg/L | Vaginal | V2 | 170 | 2649.958 | 1018.162 | 2642.232 | 2030.579 | 3397.001 | 15.629 | 5848.576 |
| 2′-Fucosyllactose | mg/L | Vaginal | V3 | 152 | 2478.073 | 933.249 | 2440.862 | 1890.143 | 3145.257 | 17.411 | 4485.034 |
| 2′-Fucosyllactose | mg/L | Vaginal | V4 | 141 | 2125.098 | 814.782 | 2043.665 | 1549.027 | 2676.863 | 27.58257 | 3984.896 |
| 2′-Fucosyllactose | mg/L | Vaginal | V5 | 133 | 1828.454 | 712.4931 | 1734.691 | 1317.535 | 2359.316 | 28.30885 | 3701.982 |
| 2′-Fucosyllactose | mg/L | Vaginal | V6 | 124 | 1641.545 | 649.3835 | 1591.755 | 1203.805 | 2113.424 | 15.80025 | 3519.046 |

TABLE V

| Visit | Estimate | SE | p-value |
|---|---|---|---|
| V1 | −720.146800 | 225.0550 | 0.001412251 |
| V2 | −99.024747 | 225.8252 | 0.661104435 |
| V3 | 6.236465 | 228.2965 | 0.978211293 |
| V4 | −25.598564 | 231.1781 | 0.911848915 |
| V5 | 109.56447 | 232.0127 | 0.636848243 |
| V6 | 47.521944 | 232.9479 | 0.838387460 |

TABLE VI

| param | unit | DELITYP | visit | N | mean | sd | median | q1.25% | q3.75% | min | max |
|---|---|---|---|---|---|---|---|---|---|---|---|
| 3-Fucosyllactose | mg/L | Caesarean | V1 | 65 | 393.4519 | 393.1355 | 287.609 | 130.66 | 423.789 | 11.41228 | 2078.125 |
| 3-Fucosyllactose | mg/L | Caesarean | V2 | 72 | 566.1434 | 507.4124 | 373.8474 | 207.3811 | 773.306 | 43.78025 | 2277.789 |
| 3-Fucosyllactose | mg/L | Caesarean | V3 | 65 | 725.427 | 597.2459 | 486.9815 | 267.68 | 909.8295 | 57.45987 | 2494.894 |
| 3-Fucosyllactose | mg/L | Caesarean | V4 | 57 | 985.2669 | 719.5609 | 833.245 | 450.0513 | 1247.438 | 86.37932 | 3278.67 |
| 3-Fucosyllactose | mg/L | Caesarean | V5 | 56 | 1072.459 | 672.5463 | 912.4742 | 583.4568 | 1527.348 | 107.8609 | 3116.744 |
| 3-Fucosyllactose | mg/L | Caesarean | V6 | 56 | 1205.29 | 728.4907 | 998.615 | 616.7708 | 1638.026 | 124.8446 | 3256.147 |
| 3-Fucosyllactose | mg/L | Vaginal | V1 | 171 | 432.5932 | 474.1818 | 236.772 | 155.992 | 419.5831 | 13.05417 | 2468.566 |
| 3-Fucosyllactose | mg/L | Vaginal | V2 | 217 | 603.3862 | 570.045 | 367.6941 | 236.801 | 659.202 | 40.313 | 2638.361 |
| 3-Fucosyllactose | mg/L | Vaginal | V3 | 195 | 717.9753 | 612.6341 | 482.526 | 304.797 | 863.2965 | 58.9511 | 2921.7 |
| 3-Fucosyllactose | mg/L | Vaginal | V4 | 185 | 965.2531 | 685.2768 | 733.0417 | 486.574 | 1293.495 | 78.17999 | 3156.162 |
| 3-Fucosyllactose | mg/L | Vaginal | V5 | 177 | 1160.955 | 807.8471 | 937.7342 | 639.918 | 1525.518 | 84.97374 | 5715.553 |
| 3-Fucosyllactose | mg/L | Vaginal | V6 | 167 | 1210.808 | 715.3666 | 1086.422 | 677.8274 | 1654.984 | 109.3491 | 3653.16 |

TABLE VII

| param | unit | DELITYP | visit | N | mean | sd | median | q1.25% | q3.75% | min | max |
|---|---|---|---|---|---|---|---|---|---|---|---|
| 3′-Sialyllactose | mg/L | Caesarean | V1 | 65 | 235.1935 | 75.25742 | 227.89 | 184.7811 | 289.532 | 99.81535 | 475.5327 |
| 3′-Sialyllactose | mg/L | Caesarean | V2 | 72 | 149.745 | 40.10661 | 144.7433 | 120.1088 | 171.303 | 76.14977 | 322.0922 |
| 3′-Sialyllactose | mg/L | Caesarean | V3 | 65 | 143.622 | 36.03897 | 137.8077 | 118.052 | 165.8281 | 79.315 | 231.2505 |
| 3′-Sialyllactose | mg/L | Caesarean | V4 | 57 | 132.0696 | 30.09482 | 130.099 | 116.138 | 150.777 | 80.62642 | 213.356 |
| 3′-Sialyllactose | mg/L | Caesarean | V5 | 56 | 132.2802 | 31.77934 | 134.5505 | 113.0306 | 150.2361 | 64.265 | 226.474 |
| 3′-Sialyllactose | mg/L | Caesarean | V6 | 56 | 132.0669 | 42.24551 | 126.0114 | 100.8918 | 154.5446 | 63.774 | 313.901 |
| 3′-Sialyllactose | mg/L | Vaginal | V1 | 172 | 260.6291 | 94.62014 | 246.5588 | 184.7556 | 313.9876 | 100.5116 | 598.693 |
| 3′-Sialyllactose | mg/L | Vaginal | V2 | 218 | 148.3798 | 37.7015 | 144.1087 | 121.7423 | 167.1077 | 73.54638 | 286.079 |
| 3′-Sialyllactose | mg/L | Vaginal | V3 | 196 | 140.2559 | 34.62782 | 134.8443 | 115.1645 | 160.0287 | 81.467 | 260.0449 |
| 3′-Sialyllactose | mg/L | Vaginal | V4 | 186 | 128.6027 | 31.92137 | 125.3999 | 106.3695 | 142.2733 | 72.162 | 248.228 |
| 3′-Sialyllactose | mg/L | Vaginal | V5 | 178 | 129.0096 | 36.57132 | 121.8506 | 104.7661 | 146.354 | 64.58818 | 271.6157 |
| 3′-Sialyllactose | mg/L | Vaginal | V6 | 168 | 132.0713 | 37.0009 | 126.208 | 104.4546 | 154.9523 | 62.77959 | 258.1019 |

TABLE VIII

| Visit | Estimate | SE | pvalue |
|---|---|---|---|
| V1 | −25.5257320 | 7.493544 | 0.0006761244 |
| V2 | 2.0483479 | 7.193966 | 0.7758901075 |
| V3 | 3.5330837 | 7.392268 | 0.6327618510 |
| V4 | 1.6203507 | 7.654074 | 0.8323721788 |
| V5 | 0.6455301 | 7.708321 | 0.9332709292 |
| V6 | −2.1164871 | 7.749014 | 0.7847918055 |

TABLE IX

| param | unit | DELITYP | visit | N | mean | sd | median | q1.25% | q3.75% | min | max |
|---|---|---|---|---|---|---|---|---|---|---|---|
| 6′-Galactosyllactose | mg/L | Caesarean | V1 | 65 | 119.1452 | 42.64857 | 118.9368 | 90.17242 | 139.3902 | 20.92559 | 233.7904 |
| 6′-Galactosyllactose | mg/L | Caesarean | V2 | 72 | 42.68249 | 31.33077 | 34.83058 | 27.92917 | 42.36709 | 17.87277 | 212.0582 |
| 6′-Galactosyllactose | mg/L | Caesarean | V3 | 65 | 27.51326 | 10.37356 | 24.9966 | 20.19846 | 32.06949 | 7.291378 | 67.68879 |
| 6′-Galactosyllactose | mg/L | Caesarean | V4 | 56 | 18.67114 | 7.313853 | 16.75487 | 13.25292 | 20.47316 | 8.203908 | 39.58748 |
| 6′-Galactosyllactose | mg/L | Caesarean | V5 | 55 | 16.10702 | 7.543112 | 14.97316 | 10.90195 | 18.77244 | 6.514313 | 42.64196 |
| 6′-Galactosyllactose | mg/L | Caesarean | V6 | 53 | 13.19458 | 5.831063 | 12.3817 | 9.427198 | 15.49682 | 6.5069 | 37.48182 |
| 6′-Galactosyllactose | mg/L | Vaginal | V1 | 172 | 136.4196 | 48.10059 | 131.6165 | 103.9052 | 167.3917 | 11.28897 | 288.7462 |
| 6′-Galactosyllactose | mg/L | Vaginal | V2 | 216 | 39.24255 | 30.32475 | 35.11423 | 28.28345 | 43.90845 | 13.62128 | 434.3118 |
| 6′-Galactosyllactose | mg/L | Vaginal | V3 | 196 | 25.10889 | 9.921284 | 23.33987 | 19.21594 | 28.64276 | 8.557955 | 88.87964 |
| 6′-Galactosyllactose | mg/L | Vaginal | V4 | 184 | 17.48279 | 8.930447 | 15.59019 | 12.47415 | 19.87539 | 6.668169 | 74.2909 |
| 6′-Galactosyllactose | mg/L | Vaginal | V5 | 171 | 13.8088 | 7.223232 | 11.8806 | 9.725494 | 15.91669 | 6.865045 | 60.46114 |
| 6′-Galactosyllactose | mg/L | Vaginal | V6 | 155 | 12.70545 | 12.21982 | 10.64685 | 8.76337 | 12.76755 | 6.482991 | 146.8862 |

TABLE X

| Visit | Estimate | SE | pvalue |
|---|---|---|---|
| V1 | −18.5559178 | 3.699432 | 5.935683e−07 |
| V2 | 1.8457853 | 3.503887 | 5.984260e−01 |
| V3 | 1.7028184 | 3.628270 | 6.389123e−01 |
| V4 | 0.1075524 | 3.822574 | 9.775575e−01 |
| V5 | 1.1119460 | 3.863319 | 7.735249e−01 |
| V6 | −0.6283119 | 3.958744 | 8.739157e−01 |

TABLE XI

| param | unit | DELITYP | visit | N | mean | sd | median | q1.25% | q3.75% | min | max |
|---|---|---|---|---|---|---|---|---|---|---|---|
| Difucosyllacto-N-Hexaose-a | mg/L | Caesarean | V1 | 47 | 165.5099 | 122.0441 | 129.6 | 92.8901 | 190.8764 | 42.45477 | 576.8931 |
| Difucosyllacto-N-Hexaose-a | mg/L | Caesarean | V2 | 59 | 246.2718 | 161.7169 | 219.318 | 124.3638 | 314.6269 | 59.53371 | 801.5431 |
| Difucosyllacto-N-Hexaose-a | mg/L | Caesarean | V3 | 50 | 217.4137 | 151.3115 | 159.0749 | 104.3207 | 300.3056 | 53.93856 | 807.2576 |
| Difucosyllacto-N-Hexaose-a | mg/L | Caesarean | V4 | 39 | 111.7462 | 93.23031 | 81.26406 | 47.114 | 148.8662 | 35.84159 | 538.5644 |
| Difucosyllacto-N-Hexaose-a | mg/L | Caesarean | V5 | 24 | 102.4559 | 66.57372 | 78.21529 | 52.82363 | 132.1428 | 34.52936 | 294.663 |
| Difucosyllacto-N-Hexaose-a | mg/L | Caesarean | V6 | 22 | 75.23462 | 51.54734 | 63.20152 | 43.66017 | 73.54147 | 33.83397 | 250.9117 |
| Difucosyllacto-N-Hexaose-a | mg/L | Vaginal | V1 | 126 | 160.1161 | 84.40191 | 147.6579 | 98.01939 | 205.3259 | 33.04833 | 470.8021 |
| Difucosyllacto-N-Hexaose-a | mg/L | Vaginal | V2 | 162 | 289.1361 | 162.581 | 245.1575 | 190.1667 | 351.798 | 33.08462 | 1086.898 |
| Difucosyllacto-N-Hexaose-a | mg/L | Vaginal | V3 | 145 | 230.2696 | 145.5384 | 187.4535 | 135.4841 | 285.3643 | 39.43415 | 779.5856 |
| Difucosyllacto-N-Hexaose-a | mg/L | Vaginal | V4 | 121 | 122.4167 | 98.74356 | 99.76598 | 55.73442 | 142.3662 | 33.55784 | 606.8606 |
| Difucosyllacto-N-Hexaose-a | mg/L | Vaginal | V5 | 83 | 96.98224 | 83.20661 | 72.06709 | 51.65362 | 97.42087 | 33.0061 | 515.2209 |
| Difucosyllacto-N-Hexaose-a | mg/L | Vaginal | V6 | 60 | 75.49285 | 52.06227 | 60.15292 | 41.82546 | 81.83647 | 33.43153 | 270.1884 |

TABLE XII

| Param | unit | DELITYP | visit | N | mean | sd | median | q1.25% | q3.75% | min | max |
|---|---|---|---|---|---|---|---|---|---|---|---|
| Fucosyllacto-N-Hexaose-III | mg/L | Caesarean | V1 | 61 | 207.018 | 167.9274 | 154.199 | 89.24603 | 239.5558 | 36.37218 | 728.4005 |
| Fucosyllacto-N-Hexaose-III | mg/L | Caesarean | V2 | 72 | 390.3576 | 225.0711 | 348.7518 | 259.5185 | 462.7193 | 57.92023 | 1379.045 |
| Fucosyllacto-N-Hexaose-III | mg/L | Caesarean | V3 | 64 | 349.7114 | 211.6457 | 302.9124 | 202.7679 | 416.5358 | 65.6812 | 1287.274 |
| Fucosyllacto-N-Hexaose-III | mg/L | Caesarean | V4 | 57 | 200.1207 | 124.2849 | 155.607 | 123.4803 | 246.3946 | 55.98325 | 737.2882 |
| Fucosyllacto-N-Hexaose-III | mg/L | Caesarean | V5 | 55 | 138.0228 | 95.67054 | 108.5833 | 75.88233 | 174.5371 | 36.56712 | 594.9286 |
| Fucosyllacto-N-Hexaose-III | mg/L | Caesarean | V6 | 49 | 108.7096 | 84.11802 | 85.62193 | 65.60018 | 124.8559 | 37.31048 | 556.4936 |
| Fucosyllacto-N-Hexaose-III | mg/L | Vaginal | V1 | 155 | 198.7845 | 150.3162 | 162.0417 | 95.10299 | 258.5028 | 36.0239 | 977.2252 |
| Fucosyllacto-N-Hexaose-III | mg/L | Vaginal | V2 | 217 | 424.4839 | 202.1756 | 378.9205 | 295.7284 | 501.3782 | 64.29686 | 1489.559 |
| Fucosyllacto-N-Hexaose-III | mg/L | Vaginal | V3 | 196 | 361.1714 | 185.5929 | 325.9032 | 244.4847 | 409.4333 | 65.67023 | 1373.042 |
| Fucosyllacto-N-Hexaose-III | mg/L | Vaginal | V4 | 186 | 210.3646 | 127.491 | 182.5266 | 127.687 | 242.0395 | 59.89979 | 826.6408 |
| Fucosyllacto-N-Hexaose-III | mg/L | Vaginal | V5 | 176 | 144.4877 | 93.71882 | 119.7476 | 78.59037 | 164.5266 | 35.00088 | 566.9521 |
| Fucosyllacto-N-Hexaose-III | mg/L | Vaginal | V6 | 161 | 113.7074 | 97.55269 | 85.02358 | 63.95139 | 122.347 | 35.37481 | 820.4363 |

TABLE XIII

| param | unit | DELITYP | visit | N | mean | sd | median | q1.25% | q3.75% | min | max |
|---|---|---|---|---|---|---|---|---|---|---|---|
| Lacto-N-Fucosylpentaose-I | mg/L | Caesarean | V1 | 53 | 1876.121 | 1032.273 | 1641.094 | 1192.514 | 2502.194 | 31.78835 | 4040.894 |
| Lacto-N-Fucosylpentaose-I | mg/L | Caesarean | V2 | 59 | 1408.053 | 871.658 | 1183.105 | 690.9282 | 1946.929 | 106.6443 | 3756.069 |
| Lacto-N-Fucosylpentaose-I | mg/L | Caesarean | V3 | 52 | 1033.576 | 651.5599 | 915.7125 | 494.8407 | 1487.785 | 77.48494 | 2386.415 |
| Lacto-N-Fucosylpentaose-I | mg/L | Caesarean | V4 | 45 | 576.722 | 422.9643 | 427.3617 | 267.154 | 733.146 | 36.497 | 1681.354 |
| Lacto-N-Fucosylpentaose-I | mg/L | Caesarean | V5 | 44 | 517.4895 | 465.1992 | 352.7363 | 199.6918 | 678.3671 | 28.33995 | 2062.946 |
| Lacto-N-Fucosylpentaose-I | mg/L | Caesarean | V6 | 44 | 403.8436 | 377.6581 | 317.463 | 127.231 | 557.85 | 27.51296 | 1913.345 |
| Lacto-N-Fucosylpentaose-I | mg/L | Vaginal | V1 | 134 | 1948.822 | 850.099 | 1921.24 | 1338.627 | 2566.746 | 27.4573 | 4311.246 |
| Lacto-N-Fucosylpentaose-I | mg/L | Vaginal | V2 | 165 | 1438.548 | 773.2372 | 1353.133 | 831.381 | 2056.579 | 49.806 | 3571.067 |
| Lacto-N-Fucosylpentaose-I | mg/L | Vaginal | V3 | 149 | 1084.234 | 620.0399 | 996.583 | 598.891 | 1496.567 | 28.866 | 3306.848 |
| Lacto-N-Fucosylpentaose-I | mg/L | Vaginal | V4 | 138 | 622.2144 | 424.2842 | 546.3944 | 285.6617 | 803.8432 | 30.669 | 2068.536 |
| Lacto-N-Fucosylpentaose-I | mg/L | Vaginal | V5 | 131 | 453.0494 | 336.5769 | 384.0603 | 191.8026 | 600.5669 | 30.394 | 1685.705 |
| Lacto-N-Fucosylpentaose-I | mg/L | Vaginal | V6 | 121 | 376.5999 | 291.0987 | 293.754 | 167.1686 | 490.82 | 43.879 | 1622.958 |

TABLE XIV

| param | unit | DELITYP | visit | N | mean | sd | median | q1.25% | q3.75% | min | max |
|---|---|---|---|---|---|---|---|---|---|---|---|
| Lacto-N-Fucosylpentaose-III | mg/L | Caesarean | V1 | 65 | 413.2556 | 172.1093 | 367.2748 | 307.2337 | 493.3068 | 117.4373 | 1026.871 |
| Lacto-N-Fucosylpentaose-III | mg/L | Caesarean | V2 | 72 | 312.3768 | 133.5057 | 290.3545 | 232.5392 | 348.0015 | 111.0194 | 857.3632 |
| Lacto-N-Fucosylpentaose-III | mg/L | Caesarean | V3 | 65 | 304.5693 | 92.47151 | 304.7266 | 247.6375 | 358.7702 | 106.2105 | 578.2936 |
| Lacto-N-Fucosylpentaose-III | mg/L | Caesarean | V4 | 57 | 347.5459 | 97.94269 | 341.2289 | 257.9483 | 414.3069 | 139.6283 | 564.1549 |
| Lacto-N-Fucosylpentaose-III | mg/L | Caesarean | V5 | 56 | 340.215 | 86.22383 | 352.4465 | 268.1773 | 402.8783 | 166.2977 | 504.8781 |
| Lacto-N-Fucosylpentaose-III | mg/L | Caesarean | V6 | 56 | 326.0637 | 100.1679 | 308.9794 | 251.3745 | 411.6478 | 158.0257 | 557.1545 |
| Lacto-N-Fucosylpentaose-III | mg/L | Vaginal | V1 | 171 | 456.4237 | 162.121 | 445.6196 | 330.8277 | 538.0647 | 145.2987 | 1151.993 |
| Lacto-N-Fucosylpentaose-III | mg/L | Vaginal | V2 | 217 | 322.514 | 143.5945 | 313.0886 | 237.5131 | 383.3557 | 79.9484 | 1751.02 |
| Lacto-N-Fucosylpentaose-III | mg/L | Vaginal | V3 | 195 | 312.9169 | 100.4753 | 297.9985 | 255.0364 | 362.9019 | 97.11791 | 951.8774 |
| Lacto-N-Fucosylpentaose-III | mg/L | Vaginal | V4 | 185 | 361.4351 | 113.9378 | 352.7379 | 293.0716 | 411.4345 | 80.61587 | 1196.495 |
| Lacto-N-Fucosylpentaose-III | mg/L | Vaginal | V5 | 177 | 357.6319 | 93.95791 | 348.8959 | 285.4443 | 418.863 | 126.226 | 679.9791 |
| Lacto-N-Fucosylpentaose-III | mg/L | Vaginal | V6 | 167 | 343.3265 | 89.48747 | 340.4357 | 284.2937 | 402.8736 | 134.2614 | 567.5952 |

TABLE XV

| Visit | Estimate | SE | pvalue |
|---|---|---|---|
| V1 | −48.00128 | 18.58564 | 0.009899282 |
| V2 | −12.56441 | 17.94400 | 0.483913173 |
| V3 | −20.26931 | 18.37248 | 0.270103059 |
| V4 | −26.40824 | 18.93954 | 0.163425500 |
| V5 | −28.32006 | 19.05713 | 0.137478627 |
| V6 | −28.87547 | 19.14550 | 0.131716343 |

TABLE XVI

| param | unit | DELITYP | visit | N | mean | sd | median | q1.25% | q3.75% | min | max |
|---|---|---|---|---|---|---|---|---|---|---|---|
| Lacto-N-Fucosylpentaose-V | mg/L | Caesarean | V1 | 43 | 101.3447 | 93.17174 | 45.57312 | 37.27781 | 170.8165 | 24.55847 | 345.4208 |
| Lacto-N-Fucosylpentaose-V | mg/L | Caesarean | V2 | 58 | 116.5227 | 106.6824 | 62.97247 | 46.82911 | 168.1558 | 24.15465 | 463.0472 |
| Lacto-N-Fucosylpentaose-V | mg/L | Caesarean | V3 | 55 | 101.3613 | 90.86575 | 59.12646 | 45.83783 | 113.8223 | 24.357 | 423.3011 |
| Lacto-N-Fucosylpentaose-V | mg/L | Caesarean | V4 | 48 | 87.35914 | 65.22655 | 67.39673 | 42.897 | 113.6167 | 24.70946 | 295.6984 |
| Lacto-N-Fucosylpentaose-V | mg/L | Caesarean | V5 | 47 | 83.51134 | 68.4666 | 55.329 | 43.103 | 93.51103 | 25.775 | 357.633 |
| Lacto-N-Fucosylpentaose-V | mg/L | Caesarean | V6 | 46 | 70.73909 | 56.04076 | 54.628 | 41.33749 | 66.49695 | 25.71721 | 320.775 |
| Lacto-N-Fucosylpentaose-V | mg/L | Vaginal | V1 | 115 | 110.9103 | 106.3813 | 51.083 | 33.85033 | 181.6103 | 24.098 | 393.2394 |
| Lacto-N-Fucosylpentaose-V | mg/L | Vaginal | V2 | 185 | 126.8562 | 120.6982 | 67.617 | 43.1213 | 189.9557 | 24.18113 | 515.4305 |
| Lacto-N-Fucosylpentaose-V | mg/L | Vaginal | V3 | 165 | 115.2792 | 102.0771 | 67.77218 | 46.073 | 148.7544 | 24.84811 | 427.275 |
| Lacto-N-Fucosylpentaose-V | mg/L | Vaginal | V4 | 158 | 91.49702 | 74.45403 | 59.39129 | 40.2565 | 118.215 | 24.31422 | 412.37 |
| Lacto-N-Fucosylpentaose-V | mg/L | Vaginal | V5 | 148 | 85.29413 | 65.64619 | 59.22437 | 39.71383 | 106.9623 | 26.214 | 360.1169 |
| Lacto-N-Fucosylpentaose-V | mg/L | Vaginal | V6 | 140 | 77.25953 | 57.13249 | 53.62788 | 38.80738 | 101.6314 | 24.172 | 325 |

TABLE XVII

| Visit | Estimate | SE | pvalue |
|---|---|---|---|
| V1 | 0.7279797 | 1.100278 | 0.000963605 |
| V2 | 1.0942023 | 1.133778 | 0.473722135 |
| V3 | 1.1136212 | 1.151505 | 0.445931186 |
| V4 | 1.1944404 | 1.147583 | 0.197442727 |
| V5 | 1.0680552 | 1.178737 | 0.689062536 |
| V6 | 1.0573885 | 1.206937 | 0.766840210 |

TABLE XVIII

| param | unit | DELITYP | visit | N | mean | sd | median | q1.25% | q3.75% | min | max |
|---|---|---|---|---|---|---|---|---|---|---|---|
| Lacto-N-hexaose (A) | mg/L | Caesarean | V1 | 59 | 72.67001 | 80.72085 | 54.46322 | 37.6074 | 79.29856 | 20.11575 | 585.5331 |
| Lacto-N-hexaose (A) | mg/L | Caesarean | V2 | 70 | 76.43889 | 45.93817 | 64.82629 | 42.81135 | 98.82219 | 17.46966 | 255.4484 |
| Lacto-N-hexaose (A) | mg/L | Caesarean | V3 | 63 | 75.39111 | 100.315 | 55.17616 | 40.61167 | 78.93574 | 16.19895 | 803.0893 |
| Lacto-N-hexaose (A) | mg/L | Caesarean | V4 | 51 | 40.25655 | 20.18467 | 34.98409 | 28.26322 | 45.32338 | 16.39287 | 112.8544 |
| Lacto-N-hexaose (A) | mg/L | Caesarean | V5 | 42 | 30.92444 | 14.60967 | 25.57597 | 20.34121 | 38.54813 | 16.03135 | 65.8527 |
| Lacto-N-hexaose (A) | mg/L | Caesarean | V6 | 37 | 26.92496 | 11.24663 | 22.20587 | 20.20135 | 30.5585 | 16.38137 | 68.12521 |
| Lacto-N-hexaose (A) | mg/L | Vaginal | V1 | 133 | 68.23454 | 40.57061 | 61.97203 | 42.24287 | 81.83799 | 16.96457 | 248.8007 |
| Lacto-N-hexaose (A) | mg/L | Vaginal | V2 | 209 | 81.20252 | 40.15512 | 70.54834 | 52.98729 | 99.06047 | 18.15176 | 247.4302 |
| Lacto-N-hexaose (A) | mg/L | Vaginal | V3 | 192 | 67.11345 | 34.43938 | 60.38396 | 44.09149 | 84.38171 | 16.21797 | 202.4682 |
| Lacto-N-hexaose (A) | mg/L | Vaginal | V4 | 166 | 39.11747 | 18.86573 | 34.04189 | 26.40764 | 46.65425 | 16.58456 | 139.2965 |
| Lacto-N-hexaose (A) | mg/L | Vaginal | V5 | 140 | 31.12354 | 16.47285 | 25.88689 | 21.49897 | 33.92165 | 16.03984 | 141.4095 |
| Lacto-N-hexaose (A) | mg/L | Vaginal | V6 | 121 | 25.79289 | 10.13618 | 22.09771 | 19.46241 | 28.72047 | 16.1077 | 69.64416 |

TABLE XIX

| param | unit | DELITYP | visit | N | mean | sd | median | q1.25% | q3.75% | min | max |
|---|---|---|---|---|---|---|---|---|---|---|---|
| Lacto-N-Neodifucosylhexaose | mg/L | Caesarean | V1 | 44 | 90.94136 | 61.31176 | 74.93681 | 49.63877 | 101.1447 | 34.51838 | 289.1655 |
| Lacto-N-Neodifucosylhexaose | mg/L | Caesarean | V2 | 22 | 79.17483 | 122.114 | 44.11073 | 38.58609 | 68.8535 | 28.86273 | 612.4524 |
| Lacto-N-Neodifucosylhexaose | mg/L | Caesarean | V3 | 17 | 69.4801 | 86.388 | 51.41437 | 32.55974 | 63.51234 | 28.32287 | 398.4921 |
| Lacto-N-Neodifucosylhexaose | mg/L | Caesarean | V4 | 18 | 66.01392 | 44.52502 | 53.72174 | 39.97562 | 71.46124 | 28.98773 | 224.0399 |
| Lacto-N-Neodifucosylhexaose | mg/L | Caesarean | V5 | 11 | 53.35166 | 19.52496 | 45.63435 | 41.5295 | 64.75294 | 30.3685 | 86.34467 |
| Lacto-N-Neodifucosylhexaose | mg/L | Caesarean | V6 | 8 | 62.95329 | 39.47884 | 49.48329 | 40.8065 | 71.30795 | 28.92047 | 151.8819 |
| Lacto-N-Neodifucosylhexaose | mg/L | Vaginal | V1 | 119 | 120.8493 | 75.65316 | 97.81401 | 63.43297 | 145.8451 | 29.3239 | 350.3302 |
| Lacto-N-Neodifucosylhexaose | mg/L | Vaginal | V2 | 66 | 57.61472 | 37.28543 | 43.66559 | 35.43083 | 67.79142 | 28.52752 | 226.4465 |
| Lacto-N-Neodifucosylhexaose | mg/L | Vaginal | V3 | 41 | 52.90657 | 29.36019 | 40.55152 | 32.46227 | 67.46135 | 28.13124 | 187.0453 |
| Lacto-N-Neodifucosylhexaose | mg/L | Vaginal | V4 | 57 | 52.09295 | 24.84705 | 41.07747 | 35.10485 | 65.58825 | 28.10296 | 114.7451 |
| Lacto-N-Neodifucosylhexaose | mg/L | Vaginal | V5 | 45 | 58.36578 | 31.36447 | 46.93235 | 34.32798 | 71.74804 | 28.12615 | 141.5695 |
| Lacto-N-Neodifucosylhexaose | mg/L | Vaginal | V6 | 37 | 62.30482 | 29.53149 | 55.41033 | 36.63324 | 84.50217 | 28.64849 | 129.1703 |

TABLE XX

| param | unit | DELITYP | visit | N | mean | sd | median | q1.25% | q3.75% | min | max |
|---|---|---|---|---|---|---|---|---|---|---|---|
| Lacto-N-Neofucosylpentaose | mg/L | Caesarean | V1 | 17 | 34.72466 | 13.71213 | 30.61731 | 25.174 | 38.26 | 20.14561 | 68.38581 |
| Lacto-N-Neofucosylpentaose | mg/L | Caesarean | V2 | 15 | 28.44653 | 11.08143 | 25.28262 | 22.1877 | 29.87695 | 19.462 | 59.17185 |
| Lacto-N-Neofucosylpentaose | mg/L | Caesarean | V3 | 13 | 25.59441 | 8.774449 | 22.36493 | 21.61821 | 25.928 | 19.325 | 53.20562 |
| Lacto-N-Neofucosylpentaose | mg/L | Caesarean | V4 | 12 | 30.07153 | 8.104769 | 28.29857 | 24.66439 | 33.37052 | 19.101 | 48.26983 |
| Lacto-N-Neofucosylpentaose | mg/L | Caesarean | V5 | 6 | 32.01022 | 5.076942 | 31.16348 | 29.321 | 33.1122 | 26.28777 | 40.978 |
| Lacto-N-Neofucosylpentaose | mg/L | Caesarean | V6 | 4 | 31.26828 | 12.20128 | 28.0655 | 23.19028 | 36.1435 | 20.8301 | 48.112 |
| Lacto-N-Neofucosylpentaose | mg/L | Vaginal | V1 | 55 | 37.29499 | 17.01259 | 32.02533 | 25.32217 | 41.53418 | 19.73896 | 92.18025 |
| Lacto-N-Neofucosylpentaose | mg/L | Vaginal | V2 | 43 | 27.9365 | 9.21598 | 26.413 | 21.44949 | 28.9162 | 19.066 | 59.578 |
| Lacto-N-Neofucosylpentaose | mg/L | Vaginal | V3 | 38 | 28.83248 | 9.175216 | 25.29176 | 22.86532 | 33.43858 | 19.002 | 53.52264 |
| Lacto-N-Neofucosylpentaose | mg/L | Vaginal | V4 | 39 | 31.3711 | 12.91261 | 27.47212 | 22.60099 | 33.42668 | 19.074 | 82.885 |
| Lacto-N-Neofucosylpentaose | mg/L | Vaginal | V5 | 36 | 26.76871 | 7.73458 | 24.61824 | 21.87222 | 28.06238 | 19.037 | 57.46976 |
| Lacto-N-Neofucosylpentaose | mg/L | Vaginal | V6 | 28 | 27.42786 | 9.972868 | 24.203 | 20.59775 | 29.55525 | 19.054 | 64.87128 |

TABLE XXI

| param | unit | DELITYP | visit | N | mean | sd | median | q1.25% | q3.75% | min | max |
|---|---|---|---|---|---|---|---|---|---|---|---|
| Lacto-N-Neotetraose | mg/L | Caesarean | V1 | 65 | 290.7465 | 129.8732 | 259.854 | 214.77 | 348.5356 | 68.118 | 699.2738 |
| Lacto-N-Neotetraose | mg/L | Caesarean | V2 | 71 | 182.0614 | 96.81752 | 165.412 | 107.2024 | 246.1066 | 46.168 | 482.0953 |
| Lacto-N-Neotetraose | mg/L | Caesarean | V3 | 63 | 151.7836 | 88.23595 | 135.6462 | 77.70653 | 209.7174 | 31.748 | 424.5886 |
| Lacto-N-Neotetraose | mg/L | Caesarean | V4 | 55 | 124.0373 | 86.13527 | 101.361 | 61.04063 | 158.4389 | 25.0473 | 349.667 |
| Lacto-N-Neotetraose | mg/L | Caesarean | V5 | 53 | 105.0904 | 74.06558 | 82.482 | 50.53774 | 138.667 | 25.20536 | 330.405 |
| Lacto-N-Neotetraose | mg/L | Caesarean | V6 | 51 | 97.70385 | 60.98458 | 83.28787 | 53.15 | 116.3868 | 25.22179 | 265.745 |
| Lacto-N-Neotetraose | mg/L | Vaginal | V1 | 172 | 312.8554 | 133.1317 | 302.8405 | 213.3848 | 396.0721 | 47.75439 | 695.668 |
| Lacto-N-Neotetraose | mg/L | Vaginal | V2 | 214 | 175.2828 | 97.05109 | 163.7154 | 97.88241 | 228.689 | 25.73309 | 597.1373 |
| Lacto-N-Neotetraose | mg/L | Vaginal | V3 | 192 | 153.886 | 76.94334 | 149.1441 | 96.43058 | 202.0949 | 26.64085 | 407.457 |
| Lacto-N-Neotetraose | mg/L | Vaginal | V4 | 177 | 128.9752 | 78.40038 | 113.072 | 74.361 | 173.843 | 25.575 | 463.904 |
| Lacto-N-Neotetraose | mg/L | Vaginal | V5 | 165 | 108.5021 | 64.88544 | 93.516 | 60.382 | 139.373 | 25.723 | 398.9075 |
| Lacto-N-Neotetraose | mg/L | Vaginal | V6 | 157 | 97.80996 | 62.02654 | 82.09836 | 47.58372 | 122 | 24.222 | 298.346 |

TABLE XXII

| param | unit | DELITYP | visit | N | mean | sd | median | q1.25% | q3.75% | min | max |
|---|---|---|---|---|---|---|---|---|---|---|---|
| Lacto-N-Tetraose | mg/L | Caesarean | V1 | 65 | 935.8954 | 745.0792 | 713.5038 | 473.8635 | 1062.362 | 78.24728 | 3526.882 |
| Lacto-N-Tetraose | mg/L | Caesarean | V2 | 72 | 1149.712 | 690.4927 | 1014.449 | 652.1858 | 1475.298 | 228.4018 | 4136.663 |
| Lacto-N-Tetraose | mg/L | Caesarean | V3 | 65 | 950.8468 | 562.6033 | 792.9896 | 592.5565 | 1246.641 | 268.697 | 3208.225 |
| Lacto-N-Tetraose | mg/L | Caesarean | V4 | 57 | 683.3828 | 398.6383 | 641.7156 | 423.991 | 741.213 | 190.144 | 2308.121 |
| Lacto-N-Tetraose | mg/L | Caesarean | V5 | 56 | 624.091 | 454.5452 | 538.274 | 333.5895 | 748.7556 | 92.696 | 2932.955 |
| Lacto-N-Tetraose | mg/L | Caesarean | V6 | 54 | 532.6976 | 394.5819 | 467.3408 | 311.4294 | 619.501 | 113.486 | 2770.281 |
| Lacto-N-Tetraose | mg/L | Vaginal | V1 | 172 | 903.2894 | 823.8913 | 678.687 | 360.4228 | 1240.144 | 21.9529 | 6714.313 |
| Lacto-N-Tetraose | mg/L | Vaginal | V2 | 218 | 1233.932 | 729.5156 | 1106.082 | 737.9908 | 1481.963 | 125.055 | 5360.815 |
| Lacto-N-Tetraose | mg/L | Vaginal | V3 | 196 | 1028.906 | 599.7885 | 921.1836 | 641.0927 | 1294.675 | 119.024 | 4011.928 |
| Lacto-N-Tetraose | mg/L | Vaginal | V4 | 185 | 704.7826 | 421.532 | 622.884 | 429.9008 | 937.0104 | 121.3419 | 2894.366 |
| Lacto-N-Tetraose | mg/L | Vaginal | V5 | 178 | 590.6303 | 382.6761 | 488.288 | 350.3931 | 745.1993 | 85.62092 | 2515.795 |
| Lacto-N-Tetraose | mg/L | Vaginal | V6 | 168 | 524.1867 | 346.4306 | 454.7523 | 287.4925 | 662.0487 | 90.424 | 3026.125 |

TABLE XXIII

| Visit | Estimate | SE | pvalue |
|---|---|---|---|
| V1 | 1.2766261 | 1.102880 | 0.01274256 |
| V2 | 0.9867720 | 1.100163 | 0.88907534 |
| V3 | 0.9643276 | 1.102012 | 0.70849776 |
| V4 | 1.0232158 | 1.104504 | 0.81742625 |
| V5 | 1.0469737 | 1.104987 | 0.64572586 |
| V6 | 1.0347385 | 1.106053 | 0.73481953 |

### Example 2

Table XIV sets out a human milk fortifier composition for in accordance with the invention. Said human milk fortifier may be for use to supplement the breast milk produced for an infant of up to 1 month of age by a mother who has given birth by C-section.

TABLE XIV

| | Per 100 kcal |
|---|---|
| Nutrient | |
| Energy (kcal) | 100 |
| Lipid (g) | 9.76 |
| DHA (mg) | 37.26 |
| Linoleic acid (mg) | 1124.76 |
| α-linolenic acid (mg) | 107.1 |
| ARA (mg) | 47.68 |
| ARA/DHA ratio | 1.28 |
| Linoleic/α-linolenic ratio | 10.5 |
| EPA (mg) | 4.06 |
| EPA/DHA ratio | 0.11 |
| MCT (g) | 1.4 |
| Protein (g) | 0.7 |
| Carbohydrate (g) | 2.3 |
| Minerals and electrolytes | |
| Na (mg) | 71.25 |
| K (mg) | 113.62 |
| Cl (mg) | 100.12 |
| Ca (mg) | 116.41 |
| P (mg) | 69.27 |
| Mg (mg) | 8.50 |
| Mn (pg) | 7.40 |
| Fe (mg) | 2.11 |
| Cu (mg) | 0.10 |
| Zn (mg) | 1.48 |
| I (μg) | 33.76 |
| Se (μg) | 6.75 |
| F (μg) | 1.40 |
| Cr (μg) | 0.88 |
| Mo (μg) | 0.93 |
| Vitamins and trace elements | |
| Vitamin A (μg) | 518.04 |
| Vitamin D (μg) | 4.61 |
| Vitamin E (mg) | 4.3 |
| Vitamin K (μg) | 8.3 |
| Vitamin C (mg) | 24.4 |
| Vitamin B1 (mg) | 0.159 |
| Vitamin B2 (mg) | 0.227 |
| Niacin (mg) | 1.99 |
| Vitamin B6 (mg) | 0.16 |
| Folic acid (μg) | 50.17 |
| Vitamin B12 (μg) | 0.26 |
| Pantothenic acid (mg) | 1.08 |
| Biotin (μg) | 4.70 |
| Choline (mg) | 10.01 |
| Inositol (mg) | 5.59 |
| Taurine (mg) | 6.98 |
| Carnitine (mg) | 4.89 |
| 2′ - Fucosyllactose | 60 |
| 3 - Fucosyllactose | 75 |
| 6′ - Galactosyllactose | 2.25 |
| Lacto-N-Fucosylpentaose-III | 4.5 |
| Lacto-N-Neodifucosylhexaose | 3.8 |
| Lacto-N-Neotetraose | 3.8 |

The composition according to the present invention may be formulated with many variations without departing from the scope of the invention as defined in the claims. The HMO per 100 kcal were calculated based on the assumption that the composition has an energy value of 670 kcal per liter.

### Example 3

Table XV sets out an HMO human milk fortifier composition in accordance with the invention. Said human milk fortifier may be for use to supplement the breast milk produced for an infant of up to 1 month of age by a mother who has given birth by C-section. Said human milk fortifier is presented as a single dose stickpack to be added for example to 100 mL expressed breast milk.

TABLE XV

| HMO | mg per stickpack (2 g format) |
|---|---|
| 2′ - Fucosyllactose | 400 |
| 3 - Fucosyllactose | 500 |
| 6′ - Galactosyllactose | 15 |
| Lacto-N-Fucosylpentaose-III | 30 |
| Lacto-N-Neodifucosylhexaose | 25 |
| Lacto-N-Neotetraose | 25 |
| Lactose | 1.05 |

### Example 4

Table XVI sets out a human milk fortifier composition. Said human milk fortifier may be for use to supplement the breast milk produced for an infant of up to 1 month of age by a mother who has given birth vaginally. Said human milk fortifier composition may be comprised in a nutritional system with the human milk fortifier composition set out in example 2 wherein said composition of example 2 is specifally tailored for use to supplement the breast milk produced for an infant of up to 1 month of age by a mother who has given birth by C-section.

TABLE XVI

| | Per 100 kcal |
|---|---|
| Nutrient | |
| Energy (kcal) | 100 |
| Lipid (g) | 9.76 |
| DHA (mg) | 37.26 |
| Linoleic acid (mg) | 1124.76 |
| α-linolenic acid (mg) | 107.1 |
| ARA (mg) | 47.68 |
| ARA/DHA ratio | 1.28 |
| Linoleic/α-linolenic ratio | 10.5 |
| EPA (mg) | 4.06 |
| EPA/DHA ratio | 0.11 |
| MCT (g) | 1.4 |
| Protein (g) | 0.7 |
| Carbohydrate (g) | 2.3 |
| Minerals and electrolytes | |
| Na (mg) | 71.25 |
| K (mg) | 113.62 |
| Cl (mg) | 100.12 |
| Ca (mg) | 116.41 |
| P (mg) | 69.27 |
| Mg (mg) | 8.50 |
| Mn (μg) | 7.40 |
| Fe (mg) | 2.11 |
| Cu (mg) | 0.10 |
| Zn (mg) | 1.48 |
| I (μg) | 33.76 |
| Se (μg) | 6.75 |
| F (μg) | 1.40 |
| Cr (μg) | 0.88 |
| Mo (μg) | 0.93 |
| Vitamins and trace elements | |
| Vitamin A (μg) | 518.04 |
| Vitamin D (μg) | 4.61 |
| Vitamin E (mg) | 4.3 |
| Vitamin K (μg) | 8.3 |
| Vitamin C (mg) | 24.4 |
| Vitamin B1 (mg) | 0.159 |
| Vitamin B2 (mg) | 0.227 |
| Niacin (mg) | 1.99 |
| Vitamin B6 (mg) | 0.16 |
| Folic acid (μg) | 50.17 |
| Vitamin B12 (μg) | 0.26 |
| Pantothenic acid (mg) | 1.08 |
| Biotin (μg) | 4.70 |
| Choline (mg) | 10.01 |
| Inositol (mg) | 5.59 |
| Taurine (mg) | 6.98 |
| Carnitine (mg) | 4.89 |

The composition according to the present invention may be formulated with many variations without departing from the scope of the invention as defined in the claims.

1. A human milk fortifier composition comprising one or more human milk oligosaccharide.

2. (canceled)

3. A human milk fortifier composition according to claim 1 wherein, the one or more human milk oligosaccharide is selected from the group consisting of a sialylated oligosaccharide, a fucosylated oligosaccharide, an N-acetylated oligosaccharide, and combinations thereof.

4. A human milk fortifier composition according to claim 1 wherein, the human milk oligosaccharide is selected from the group consisting of: 2′-fucosyllactose, 3′-fucosyllactose, 3′-sialyllactose, 6′-galactosyllactose, difucosyllacto-N-Hexose-a, fucosyllacto-N-hexose-III, Lacto-N-fucosylpentaose-I, Lacto-N-fucosylpentaose-III, Lacto-N-fucosylpentaose-V, Lacto-N-hexaose, Lacto-N-Neodifucosylhexaose, Lacto-N-Neofucosylpentaose, Lacto-N-Neotetraose, Lacto-N-Tetraose, and any combination combinations thereof.

5. A human milk fortifier composition according to claim 4 wherein, the human milk oligosaccharide is selected from the group consisting of; 2′-fucosyllactose, 3′-sialyllactose, 6′-galactosyllactose, Lacto-N-fucosylpentaose-III, Lacto-N-Neodifucosylhexaose, Lacto-N-Neotetraose, and any combination combinations thereof.

6. A human milk fortifier composition according to claim 1 wherein the human milk fortifier composition comprises an HMO in a range of 0.1 to 10000 mg/L.

7. A human milk fortifier composition according to claim 1 wherein the human milk fortifier is specifically tailored for an infant of a select age.

8. A human milk fortifier composition according to claim 1, wherein the composition further comprises one or more ingredient selected from the group consisting of vitamins, minerals, protein, carbohydrates, and probiotics.

9. A method of preparing a human milk fortifier tailored to fortify the breast milk of a women who has given birth via caesarean section, comprising: measuring out an appropriate amount of a human milk fortifier comprising one or more human milk oligosaccharides and mixing it with a diluent and/or additive.

10-13. (canceled)

14. A nutritional system comprising:
a. a human milk fortifier composition tailored to fortify the breast milk of a women who has given birth via caesarean section, and
b. a human milk fortifier composition,
wherein,
the human milk fortifier composition tailored to fortify the breast milk of a women who has given birth via caesarean section comprises an HMO in a concentration higher than in the human milk fortifier composition.

15. (canceled)
